(19) United States
(12) Patent Application Publication
(10) Pub. No.: US 2024/0416776 A1
(43) Pub. Date: Dec. 19, 2024

(54) POSITIONING UNIT FOR A CHARGING STATION, AND METHOD FOR ESTABLISHING CONTACT

(71) Applicant: SCHUNK TRANSIT SYSTEMS GMBH, Wettenberg (DE)

(72) Inventors: Alexander Fuhr, Wettenberg (DE); Holger Leib, Heuchelheim (DE); Lothar Schneider, Lahnau (DE); Matthias Domes, Bad Nauheim (DE); Timo Staubach, Herbstein (DE)

(21) Appl. No.: 18/704,104

(22) PCT Filed: Oct. 25, 2021
(86) PCT No.: PCT/EP2021/079561

§ 371 Date: Apr. 24, 2024

(51) Int. Cl. B60L 53/35; B60L 53/16; B60L 53/60

(52) U.S. Cl. CPC B60L 53/35; B60L 53/16; B60L 53/60; B60L 2200/18

(57) ABSTRACT

The invention relates to a positioning unit (10) and a method for establishing an electrically conductive connection between a stationary charging station and a vehicle, in particular an electric bus or the like, the positioning unit being designed so as to be disposable above a vehicle, an electric charging contact (11) of the positioning unit being movable in relation to a charging contact surface (13) of the vehicle and being contactable therewith by means of the positioning unit, the positioning unit having a positioning device (14) and a drive device (15) for driving the positioning unit, the charging contact being able to be positioned between a contact position for power transmission and a retracted position for power interruption by means of the positioning device. The drive device has a displacement drive (16) having a support means (17) coupled with the positioning unit, a traction force being able to be transmitted in such a manner to the positioning device using the support means (17) that the positioning device is moveable between the contact position and the retracted position by means of the displacement drive.

The invention relates to a positioning unit and a method for establishing an electrically conductive connection between a stationary charging station and a vehicle, in particular an electric bus or the like, the positioning unit being designed so as to be disposable above a vehicle, an electric charging contact of the positioning unit being movable in relation to a charging contact surface of the vehicle and being contactable therewith by means of the positioning unit, the positioning unit having a positioning device and a drive device for driving the positioning device, the charging contact being able to be positioned between a contact position for power transmission and a retracted position for power interruption by means of the positioning device.

Such positioning units and methods are known from the state of the art and are regularly used in electrically powered vehicles which travel between stops. The vehicles can be electric buses, but in principle also other vehicles, such as a train or a streetcar, which are not permanently electrically connected to a contact wire or similar. In these vehicles, an electric energy storage device is charged by a charging station when the journey is interrupted at a stop or a vehicle depot. The vehicle is electrically connected to the charging station, the vehicle's energy storage device being charged, for example during a short stop or overnight.

A charging contact of the positioning unit is then moved towards a charging contact surface on a roof of the vehicle by means of the positioning device and an electrical connection is established. For instance, a positioning unit can have at least four charging contacts, two charging contacts then being able to be used regularly for energy transmission, one charging contact as a ground conductor and another charging contact for data transmission. When connecting charging contacts to the respective charging contact surfaces of the vehicle, it is essential that the respective charging contact is pressed onto the charging contact surface with a sufficient but not excessive contact force in order to establish a secure electrical connection. To produce a defined contact force, the known positioning units have a spring element having, for example, a contact spring to generate the contact force and a return spring that acts against a weight of the positioning device. Furthermore, a relative distance between contacting positions and retracted positions can be used variably so that vehicles of different heights can also be contacted using the desired contact force. Furthermore, buses in particular can be lowered in the area of a bus stop to facilitate access for people with physical disabilities, for example. This lowering of the bus causes a change in height of a charging contact surface relative to the road surface and, if the lowering only takes place on one side of the bus, causes the bus to tilt around its longitudinal axis. This movement of the vehicle requires the contacting position of the positioning unit to be adjusted without in-terrupting the charging process. This can be achieved by a spring element or the use of sensors during a charging process. Such a positioning unit is known, for example, from WO 2017/042065 A1. The disadvantage here is that the positioning unit is structurally complex, which signifi-cantly increases the manufacturing and operating costs.

It is therefore the object of the invention to propose a positioning unit and a method for establishing an electrically conductive connection between a stationary charging station and a vehicle, which both allow a safe contacting of the vehicle at simultaneously low acquisition and operating costs.

This object is attained by a positioning unit having the features of claim 1 by a method having the features of claim 15.

The positioning unit according to the invention for establishing an electrically conductive connection between a stationary charging station and a vehicle, in particular an electric bus or the like, is designed so as to be disposable above a vehicle, an electric charging contact of the positioning unit being movable in relation to a charging contact surface of the vehicle and being contactable therewith by means of the positioning unit, the positioning unit having a positioning unit and a drive device for driving the positioning unit, the charging contact being able to be positioned between a contact position for power transmission and a retracted position for power interruption by means of the positioning device, the drive device having a displacement drive having a support means coupled with the positioning device, a traction force being able to be transmitted in such a manner to the positioning device using the support means that the positioning device is moveable between the contact position and the retracted position by means of the displacement drive.

The positioning unit is therefore a component of a stationary charging station for an electrically powered vehicle and is used to move the at least one charging contact of the charging station and/or the positioning unit onto a charging contact surface of the vehicle, which is preferably disposed on a vehicle roof, and to make electrical contact therewith. This makes it possible to supply the vehicle with electrical energy at a stop or a vehicle depot and to store this energy in the vehicle. The movement of the charging contact(s) to the respective charging contact surface is car-ried out using the positioning unit, which is disposed above the vehicle on, for example, a mast, an underpass, a support structure or a ceiling structure of a hall. The charging contact or charging contacts are disposed on a lower end of the positioning unit for this purpose and can be moved from an upper retracted position to a lower contacting position for current transmission and/or contacting of the charging contact surfaces. In the contacting position, a defined contact force is exerted on the respective charging contact surfaces. In the retracted position, the charging contact(s) is stored when the positioning unit is not in use.

According to the invention, it is provided that the displacement drive acts on the positioning device via the support means. The deformable support means serves to transmit a traction force to the positioning device, to which the support means is coupled and/or is mechanically indirectly or directly connected. The drive device is designed so that the traction force can be used to move the positioning device, and thus the charging contact, between the contacting position and the retracted position. This makes it possible to completely dispense with a spring element and to actuate the positioning device solely by the deformable or movable support means. This makes the positioning unit easier and cheaper to manufacture.

The support means can be at least a belt, a rope or a chain. Such a support means can be easily stored on the positioning unit. A stroke length and/or a movement length of the charging contact can also be easily var-ied with such a support means. At the same time, a traction force can be safely transmitted to the positioning device via the support means when the support means is connected to the positioning device. The positioning device can then be moved from the contacting position to the retracted position by exerting the traction force. Conversely, the positioning device can be lowered from the retracted position to the contacting position by extending and/or releasing the corresponding support means. Nevertheless, several support means, even of different types, can be provided.

In this manner, a weight of at least the positioning device and the charging contact can produce a displacement force countering the traction force, a contact force being able to be exerted on the charging contact surface by means of the weight. The weight caused by a mass of at least the positioning device and the charging contact alone can be held by the support means. This weight then corresponds to the traction force acting in the opposite direction in the support means, the displacement force acting against the traction force then acting on the positioning device or the drive device. In addition to the positioning device and the charging contact, other components of the positioning unit, which are designed to move together with the positioning device and the charging contact, can also produce the weight or the displacement force. If the charging contact now lies on the charging contact surface of the vehicle in the contacting position, the contact force essentially corresponds to the weight and/or the displacement force. If several charging contacts are provided, the contact force of the individual charging contacts can result proportionally from the weight. The positioning unit can advantageously have a weight which always ensures an equally large contact force is produced.

The displacement drive can be formed having a winch for actuating the support means. The winch can be designed in the form of a rope winch, for example. Since the support means is connected to the positioning device, the positioning device can be easily raised or lowered by actuating the winch. A complex spring element is then no longer required and the drive device can be easily formed.

The displacement drive can be designed such that a slack of the support means in the contact position is detectable by the displacement drive. When the charging contact is lowered to the contacting position, the deformable support means can slack. A slack is understood to mean that the support means is slack and/or not under tension and no traction force or force is transmitted. In order to prevent the support means from completely unwinding or settling on the vehicle or the charging contact surface, it may be necessary to detect the slack of the support means. For example, the displacement drive can be used to detect whether a traction force is being applied to the support means. If this is not the case, the displacement drive can be switched off or further conveying of the support means can be stopped. Sensors can also be provided which detect a slack in the support means.

The displacement drive can have an electric motor, by means of which a reel, a drum, a bobbin or a chain wheel of the displacement drive can be driven. The electric motor can be connected directly or indirectly, for example via a gearbox, to the reel, the drum, the bobbin or the chain wheel. The support means can thus be easily actuated and/or wound up. The electric motor can be a brushless electric motor or a stepper motor. If the support means is a belt, a rope or a chain, the support means can be wound onto the reel, the drum or the bobbin and thus be stored. If the support means is a chain, the chain can be operated using the chain wheel, for example, and be deposited in a container provided for this purpose. Depending on the design of the chain, the chain wheel can be formed by a capstan. The support means can thus be stored particularly compactly on the positioning unit.

The displacement drive can have a controller by means of which the electric motor is controllable and/or a rotational speed of the electric motor is controlled. When controlling the rotational speed or the acceleration of the electric motor, it can be intended that the charging contact is moved at a constant speed, at least in sections. A delay or acceleration of a movement of the charging contact can also be provided by controlling the rotational speed of the electric motor before reaching the contacting position or the retracted position. Optionally, the displacement drive can also be designed to be self-locking, depending on the type of electric motor and any gearbox used. The positioning device can then be easily moved into a desired position and fixed in place without any further aids. The displacement drive can also have a backup battery which, in the event of a power failure or other malfunction, ensures that the positioning device automatically moves to the retracted position owing to an emergency power supply from the backup battery. The backup battery can be integrated into the displacement drive. In addition to the electric motor, other suitable drives can also be provided.

The displacement drive can be designed such that a torque of the electric motor is detectable by the controller, the contact position being determinable by the controller as a function of the torque of the electric motor. The controller can be formed from control electronics for the electric motor. In this context, it may be possible for the control electronics to be integrated directly in the electric motor. The controller can detect a torque of the electric motor via the energy applied, for example, and control the electric motor in such a manner that the contacting position and/or retracted position of the positioning device is recognized. This can be achieved because a detected torque is comparatively high in the retracted position and a detected torque is comparatively low in the contacting position. It is then possible to actively adjust a direct force effect on the positioning device, if necessary on the charging contact, optionally also depending on various influencing factors. This makes it possible to produce a constant contact force on the charging contact surface via the weight regardless of a relative distance between the charging contact surface and the positioning unit and/or a height of the vehicle. If, for example, a vehicle is lowered after reaching the contacting position by increasing the load, a torque can be generated in the support means by producing a traction force and can be detected by the controller. The controller can then lower the positioning device further accordingly via the electric motor.

The displacement drive and/or the positioning device can have a position sensor or a path sensor, by means of which a position of the charging contact is determinable, and/or a force sensor, by means of which a contact force and/or a traction force is determinable. This also makes it possible to limit a contact force, the limitation being able to take place by switching off the displacement drive when a certain force or traction force has been reached in the support means. Possible damage to the positioning unit or the charging contact surface can thus be easily pre-vented. Optionally or additionally, an incremental or absolute encoder can be used as a path sensor. It is then always possible to determine the exact working position of the positioning device. The positioning device can also have position-dependent actuated limit switches and/or force-dependent actuated pressure switches. A pressure switch can be disposed directly on the charging contact. Depending on the design of the positioning device, the relevant sensors can also be disposed on joints or bearings of the positioning device.

The positioning device can therefore form a hinged-arm element. This makes it possible to guide the charging contact along a predetermined path from the retracted position to the contacting position and back. In principle, the positioning device can also consist of telescopic guide ele-ments.

The hinged-arm element can be designed as a one-arm system or as a crossbar system, preferably having a parallelogram guide, or as a pantograph. In this manner, the hinged-arm system can enable parallel movement of the charging contact from a retracted position of the charging contact to the contacting position on the charging contact surface of the vehicle.

The positioning unit can have a support frame for fastening the positioning device above a vehicle, the displacement drive being disposed on the support frame. The support frame can be designed so that it can be easily attached to a mast or a ceiling structure of a building. The displacement drive can therefore also be connected to the support frame. However, since the displacement drive acts on the positioning device solely via the support means, it can also be intended for the displacement drive to be disposed directly on a mast or a building independently of the support frame.

The positioning unit can have a contacting element having two charging contact carriers having at least two charging contacts disposed thereon, the charging contacts being able to be connected to each other via a parallel linkage of the contacting element having two connective links disposed parallel thereon and having two carrier links disposed parallel thereon, the carrier links each being able to be connected to the connective links in one of two parallel movement planes via spaced-apart connective arms and being able to form a parallelogram together with the connective links. With such a positioning unit, at least four charging contacts can be moved onto a charging contact surface of a vehicle each and be electrically contacted therewith. It is also possible to evenly dis-tribute or produce the contact force on the respective charging contact surfaces. The contacting element can be disposed in such a manner at a lower end of the positioning device that the contactor is held essentially centrally or in a center of gravity. The parallel linkage can be formed from comparatively long connective rods and short carrier links, which are disposed vertically and connected to the connective rods via the connective joints. The connective rods can thus be inclined relative to a hor-izontal plane, the carrier links always being able to be disposed vertically within the two parallel movement planes. If the connective joints are disposed coaxially to the carrier joints, force is always evenly distributed from a contact force exerted centrally on the contactor to the two carriers, regardless of the inclination of the connective rods. The center of gravity of the contacting element can then also be almost centrally positioned due to the symmetrical design of the contacting element, resulting in an even distribution of the contact force on the charging contacts.

The connective links can be connected to a lower end of the positioning device in a parallel carrier plane extending centrally to the movement plane via two spaced-apart carrier arms, the charging contact carriers each being able to be connected to the carrier link via a hinged joint, the hinged joints being able to be disposed orthogonal in relation to the connective arms, the charging contact supports each coaxially being able to hold the charging contacts in relation to the hinged joints. The charging contact carriers can each be disposed on the carrier of the hinged joint. Since the charging contacts on the respective charging contact carrier are also disposed coaxial relative to the hinged joint, the contact force can be distributed proportionally to the two charging contacts disposed on the charging contact carrier via the carrier joint and/or the hinged joint. If the hinged joints are disposed orthogonal relative to the connective joints, it is possible to adapt the height of the charging contacts to a transverse and longitudinal inclination of a vehicle relative to the vehicle and at the same time to achieve reliable contacting of the respective charging contact surfaces of the vehicle with an essentially equal or pro-portional contact force using simple means.

In the method according to the invention for establishing an electrically conductive connection between a stationary charging station and a vehicle, in particular an electric bus or the like, an electric charging contact of the positioning unit is moved above a vehicle in relation to a charging contact surface of the vehicle and being contacted therewith by means of a positioning unit of the charging station, a positioning device of the positioning unit being driven by a drive device of the positioning unit, the charging contact being positioned between a contact position for power transmission and a retracted position for power interruption by means of the positioning device, a traction force being transmitted in such a manner to the positioning device by means of a support means of a displacement drive of the drive device, the support means being coupled with the positioning device, that the positioning device is moved between the contact position and the retracted position by means of the displacement drive. With regard to the advantages of the method according to the invention, reference is made to the description of the advantages of the positioning unit according to the invention.

A movement of the positioning device and the retracted position to the contacting position can comprise the following steps:
a. moving the positioning device and the electric charging contact disposed thereon downwards by means of the displacement drive by releasing the support means.
b. stopping the support means in the contact position by abutting the electric charging contact against the charging contact surface.
c. and simultaneously producing the contact force solely via a weight of at least the positioning device and the charging contact

The contact position and the contact force can be produced irrespective of a relative distance of the charging contact surface of the vehicle below the positioning unit to the retracted position of the positioning unit. This makes it possible to contact vehicles of differing heights with the positioning unit relative to a road surface. Preferably, the charging contact surface of the vehicle can be disposed on a vehicle roof or at another suitable location on an upper side of the vehicle.

The contact force can be produced consistently in the contact position while a relative distance of the charging contact surface of the vehicle below the positioning unit to the retracted position of the positioning unit is changed. A change in the relative distance of the charging contact surface also results in a change in the distance of the charging contact surface to a roadway. A change in the relative distance can be caused by lowering the vehicle via a chassis or by loading the vehicle. The fact that the contact force can essentially be produced by the weight of the positioning device and the charging contact(s) and any contacting element present means that the contact force can be essentially constant, even if the relative distance is changed. Even if the support means sags a little in the contacting position, a movement of the vehicle can be compen-sated within limits without the contact force changing.

Further advantageous embodiments of the method result from the description of the features of the dependent claims referring to device claim 1.

In the following, preferred embodiments of the invention are described in further detail with reference to the enclosed drawings.

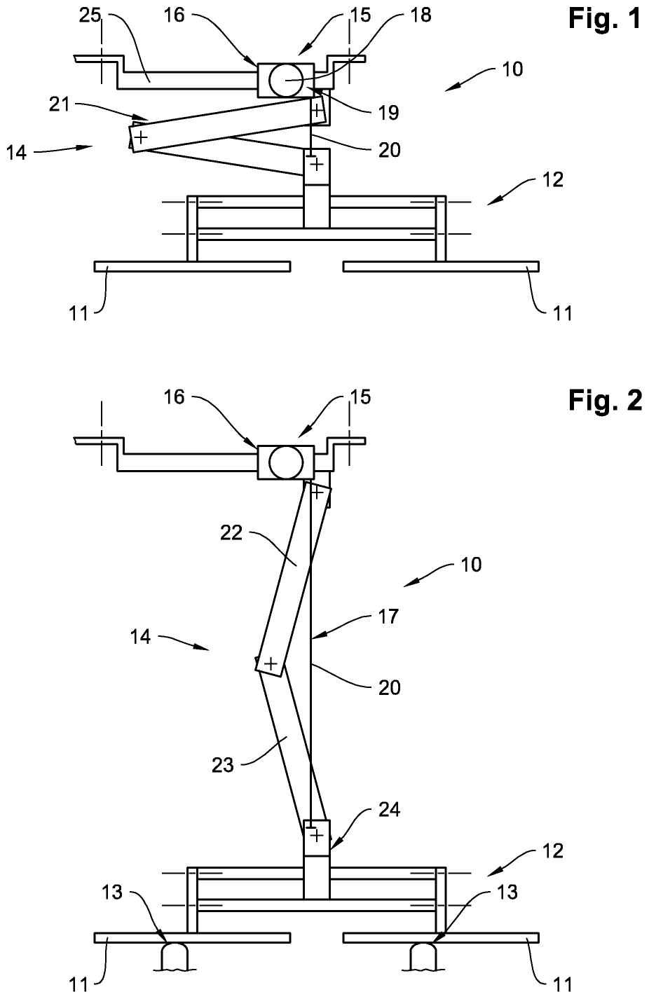

FIG. 1 shows a lateral view of a first embodiment of a positioning unit in a first working position;

FIG. 2 shows the positioning unit in a second working position:

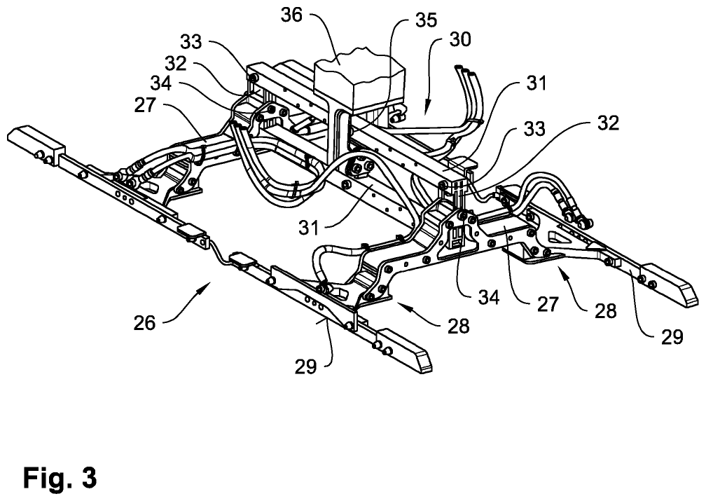

FIG. 3 shows a perspective view of a contacting element.

FIGS. 1 and 2 show a positioning unit 10 for establishing an electrically conductive connection between a stationary charging station (not shown) and a vehicle (not shown), in particular an electric bus or the like, disposed below the positioning unit 10. The positioning unit 10 can be used to move four electrical charging contacts 11 of the positioning unit 10, which are disposed on a contacting element 12 of the positioning unit 10 in this case, relative to charging contact surfaces 13 on a roof of the vehicle and be contacted therewith. The positioning unit 10 comprises a positioning device 14 and a drive device 15 for driving the positioning device 14. By means of the positioning device 14, the charging contacts 11 are positioned between a retracted position or rest position shown in FIG. 1 for storing the charging contacts 11 and a contacting position shown in FIG. 2 for power transmission.

The drive device 15 has a displacement drive 16 having a support means 17 coupled to the positioning device 14. The displacement drive 16 is formed by a winch 19 designed having an electric motor 18, the support means 17 being formed by a rope 20, which can be raised or lowered using the winch 19. The displacement drive 16 also comprises a controller (not shown) for controlling and regulating the electric motor 18. The positioning device 14 is further formed by a hinged-arm device 21, consisting essentially of two articulated arms 22 and 23. The contacting element 12 and the rope 20 are fastened to a lower end 24 of the positioning device 14. The positioning unit 10 also has a support frame 25 for fastening the positioning device 14 to a mast (not shown) or a ceiling of a hall or the like. The winch 19 is fastened to the support frame 25.

By actuating the electric motor 18, the rope 20 can now be wound up or released using the winch 19, so that a length of the rope 20 released by the winch 19 can be changed. Accordingly, as can be seen in FIGS. 1 and 2, the contacting element 12 having the charging contacts 11 can be raised to the retracted position or lowered to the contacting position. A weight of the positioning device 14 and/or the contacting element 12 and the charging contacts 11 causes a traction force in the rope 20, which essentially counteracts and corresponds to the displacement force which must be applied by the electric motor 18 to raise the charging contacts 11. If the charging contacts 11 rest on the charging contact surfaces 13 and the rope 20 is unloaded, i.e., no traction force is transmitted via the rope 20 or the rope 20 sags a little, the weight acts as a contact force on the charging contact surfaces 13, the weight being distributed proportionally to the respective charging contacts 11. The displacement drive 16 has at least one sensor (not shown) which can be used to determine the position of the charging contacts 11. This position can easily be de-termined via the displacement drive 16 on the basis of a torque of the electric motor 18 of a traction force or the like.

FIG. 3 shows a contacting element 26, which can also be used with the positioning unit described above. The contacting element 26 has two charging contact carriers 27, to the distal ends 28 of which contact strips 29 are fastened, thus forming the charging contacts 11. The essentially arc-shaped or O-shaped charging contact carriers 27 are connected to a parallel linkage 30 of the contacting element 26, formed from connective rods 31 and vertically disposed carrier links 32. The connective rods 31 are movably connected to the carrier links 32 via connective joints 33, the charging contact carriers 27 each being movably connected to the carrier rod 32 via a hinged joint 34. Furthermore, carrier joints 35 movably connect a lower end 36 of a positioning device (not shown) to the connective rods 31.

1. A positioning unit (10) for establishing an electrically conductive connection between a stationary charging station and a vehicle, in particular an electric bus or the like, the positioning unit being designed so as to be disposable above a vehicle, an electric charging contact (11) of the positioning unit being movable in relation to a charging contact surface (13) of the vehicle and being contactable therewith by means of the positioning unit, the positioning unit having a positioning device (14) and a drive device (15) for driving the positioning unit, the charging contact being able to be positioned between a contact position for power transmission and a retracted position for power interruption by means of the positioning device, wherein the drive device has a displacement drive (16) having a support means (17) coupled with the positioning unit, a traction force being able to be transmitted in such a manner to the positioning device using the support means (17) that the positioning device is moveable between the contact position and the retracted position by means of the displacement drive.

2. The positioning unit according to claim 1, wherein the support means (17) is at least a belt, a rope (20) or a chain.

3. The positioning unit according to claim 1, wherein a weight of at least the positioning device (14) and the charging contact (11) produces a displacement force countering the traction force, a contact force being able to be exerted on the charging contact surface (13) by means of the weight.

4. The positioning unit according to claim 1, wherein the displacement drive (16) is formed having a winch (19) for actuating the support means (17).

5. The positioning unit according to claim 1, wherein the displacement drive (16) is designed such that a slack of the support means (17) in the contact position is detectable by the displacement drive.

6. The positioning unit according to claim 1, wherein the displacement drive (16) has an electric motor (18), by means of which a reel, a drum, a bobbin or a chain wheel of the displacement drive is drivable.

7. The positioning unit according to claim 6, wherein the displacement drive (16) has a controller by means of which the electric motor (18) is controllable and/or a rotational speed of the electric motor is controlled.

8. The positioning unit according to claim 6, wherein the displacement drive (16) is designed such that a torque of the electric motor (18) is detectable by the controller, the contact position being determinable by the controller as a function of the torque of the electric motor.

9. The positioning unit according to claim 1, wherein the displacement drive (16) and/or the positioning device (14) has a position sensor or a path sensor, by means of which a position of the charging contact (16) is determinable, and/or a force sensor, by means of which a contact force and/or a traction force is determinable.

10. The positioning unit according to claim 1, wherein the positioning device (14) forms a hinged-arm element (21).

11. The positioning unit according to claim 10, wherein the hinged-arm element (21) is designed as a one-arm system or as a crossbar system, preferably having a parallelogram guide, or as a pantograph.

12. The positioning unit according to claim 1, wherein the positioning unit (10) has a support frame (25) for fastening the positioning device (14) above a vehicle, the displacement drive (16) being disposed on the support frame.

13. The positioning unit according to claim 1, wherein the positioning unit (10) has a contacting element (12, 26) having two charging contact carriers (27) having at least two charging contacts (11) disposed thereon, the charging contacts being connected to each other via a parallel linkage (30) of the contacting element having two connective links (31) disposed parallel thereon and having two carrier links (32) disposed parallel thereon, the carrier links each being connected to the connective links in one of two parallel movement planes via spaced-apart connective arms (33) and forming a parallelogram together with the connective links.

14. The positioning unit according to claim 13, wherein the connective links (31) are connected to a lower end (24, 36) of the positioning device (14) in a parallel carrier plane extending centrally to the movement plane via two spaced-apart carrier arms (35), the charging contact carriers (27) each being connected to the carrier link (32) via a hinged joint (34), the hinged joints being disposed orthogonal in relation to the connective arms (33), the charging contact supports each coaxially holding the charging contacts (11) in relation to the hinged joint.

15. A method for establishing an electrically conductive connection between a stationary charging station and a vehicle, an electric charging contact (11) of the positioning unit being moved above a vehicle in relation to a charging contact surface (13) of the vehicle and being contacted therewith by means of a positioning unit (10) of the charging station, a positioning device (14) of the positioning unit being driven by a drive device (15) of the positioning unit, the charging contact being positioned between a contact position for power transmission and a retracted position for power interruption by means of the positioning device, wherein a traction force is transmitted in such a manner to the positioning device by means of a support means (17) of a displacement drive (16) of the drive device, the support means being coupled with the positioning device, that the positioning device is moved between the contact position and the retracted position by means of the displacement drive.

16. The method according to claim 15, wherein a movement of the positioning device (14) from the retracted position to the contact position comprises the following steps:
a. moving the positioning device and the electric charging contact (11) disposed thereon downwards by means of the displacement drive (16) by releasing the support means (17);
b. stopping the support means in the contact position by abutting the electric charging contact against the charging contact surface (13);
c. and simultaneously producing the contact force solely via a weight of at least the positioning device and the charging contact.

17. The method according to claim 15, wherein the contact position and the contact force are produced irrespective of a relative distance of the charging contact surface (13) of the vehicle below the positioning unit (10) to the retracted position of the positioning unit.

18. The method according to claim 15, wherein the contact force is produced consistently in the contact position while a relative distance of the charging contact surface (13) of the vehicle below the positioning unit (10) to the retracted position of the positioning unit is changed.
